(19) United States
(12) Patent Application Publication
(10) Pub. No.: US 2022/0141900 A1
(43) Pub. Date: May 5, 2022

(54) COMMUNICATION METHOD, COMMUNICATION SYSTEM, AND WIRELESS COMMUNICATION DEVICE

(71) Applicant: Sony Group Corporation, Tokyo (JP)

(72) Inventor: Hiroshi Kanma, Chiba (JP)

(21) Appl. No.: 17/431,309

(22) PCT Filed: Feb. 10, 2020
(86) PCT No.: PCT/JP2020/005071

§ 371 Date: Aug. 16, 2021

(30) Foreign Application Priority Data
Mar. 7, 2019 (JP) 2019-041780

(51) Int. Cl. H04W 76/15; H04W 72/04; H04L 5/00

(52) U.S. Cl. CPC H04W 76/15; H04L 5/0048; H04W 72/0453

(57) ABSTRACT

A communication method includes; transmitting, by a first wireless communication device, channel designation information designating a channel to be used for a second communication to a second wireless communication device through a first communication; activating, by the second wireless communication device, a communication function of performing the second communication through the designated channel, and transmitting, by the first wireless communication device, a connection request for the second communication using the designated channel to the second wireless communication device.

### TECHNICAL FIELD

The present technology relates to a communication method, a communication system, and a wireless communication device.

### BACKGROUND ART

Conventionally, communication between a plurality of devices through Wi-Fi, Bluetooth (registered trademark), near field communication (NFC), and the like was able to be performed. In general, Wi-Fi can allow high-speed large-capacity data communication but requires high power consumption. On the other hand, Bluetooth (registered trademark) and NFC can allow only low-speed small-capacity data communication but require lower power consumption than Wi-Fi Accordingly, a scheme called Wi-Fi handover in which communication is performed through Bluetooth (registered trademark) having low power consumption in a steady state and switches to Wi-Fi connection when high-speed large-capacity data communication is required has been proposed.

A handover requires a time to switch connection methods, and a method for reducing the switching time has been proposed (PTL 1).

### CITATION LIST

### Patent Literature

[PTL 1]

JP 2016-201840A

### SUMMARY

### Technical Problem

In addition, according to the recent spread of communication devices such as smartphones, wireless bands used for communication such as Wi-Fi and Bluetooth (registered trademark) tend to be crowded. To secure a band in which stable communication can be performed in such a situation, it is necessary to scan neighboring radio conditions. However, when scanning is performed after Wi-Fi starts, there are problems that a time is required for scanning and connection establishment; takes a time. The same problems also occur when a handover of switching from a connected communication method to another communication method is performed.

The present technology was made in view of such circumstances and an object thereof is to provide a communication method, a communication system, and a wireless communication device capable of reducing a time required for communication switching.

### Solution to Problem

To solve the above-described problems, a first technology is a communication method including: transmitting, by a first wireless communication device, channel designation information designating a channel to be used for a second communication to a second wireless communication device through a first communication; activating, by the second wireless communication device, a communication function such that the second communication is performed through the designated channel; and transmitting, by the first wireless communication device, a connection request for the second communication using the designated channel to the second wireless communication device.

In addition, a second technology is a communication system including: a first wireless communication device; and a second wireless communication device, wherein the first wireless communication device transmits channel designation information designating a channel to be used for a second communication to the second wireless communication device through a first communication, the second wireless communication device activates a communication function such that the second communication is performed through the designated channel, and the first wireless communication device transmits a connection request for the second communication using the designated channel to the second wireless communication device.

In addition, a third technology is a wireless communication device configured to transmit channel designation information designating a channel to be used for a second communication to another device through a first communication and to transmit a connection request for the second communication using the designated channel to the other device.

Furthermore, a fourth technology is a wireless communication device configured to receive channel designation information used for a second communication transmitted from another device through a first communication and to activate a communication function such that the second communication is performed through a designated channel.

### BRIEF DESCRIPTION OF DRAWINGS

FIG. 1 is a block diagram illustrating a configuration of a communication system 10.

FIG. 2 is an explanatory diagram of channels in Wi-Fi in a 2.4 GHz band.

FIG. 3 is an explanatory diagram of channels in Wi-Fi of 5 GHz band.

FIG. 4A is a block diagram illustrating a configuration of a first wireless communication device 100, and FIG. 4B is a block diagram illustrating a configuration of a second wireless communication device 200.

FIG. 5 is a flowchart illustrating communication switching processing.

FIG. 6 is a flowchart illustrating a modified example of communication switching processing.

### DESCRIPTION OF EMBODIMENTS

Hereinafter, embodiments of the present technology will be described with reference to the drawings. The description will be given in the following order.

### 1. EMBODIMENT

[1-1. Configuration of communication system 10]

[1-2. Configuration of first wireless communication device 100]

[1-3. Configuration of second wireless communication device 200]

[1-4. Communication switching processing]

### 2. MODIFIED EXAMPLES

### 1. EMBODIMENT

[1-1. Configuration of Communication System 10]

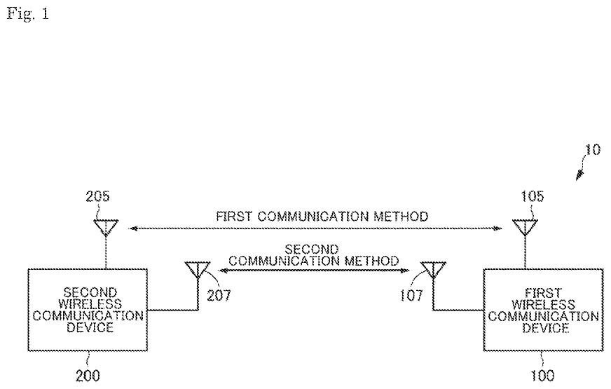

First, a communication system 10 according to the present technology will be described. As illustrated in FIG. 1, the communication system 10 includes a first wireless communication device 100 and a second wireless communication device 200. The first wireless communication device 100 and the second wireless communication device 200 have a wireless communication function and can connect to each other using wireless communication to transmit/receive various types of data. In the present embodiment, the first wireless communication device 100 and the second wireless communication device 200 can communicate with each other through at least two communication methods, a first communication method and a second communication method.

The first wireless communication device 100 and the second wireless communication device 200 are wireless communication devices based on Institute of Electrical and Electronics Engineers (IEEE) 802.11 that enables Peer to Peer (P2P) connection. The first wireless communication device 100 and the second wireless communication device 200 can form a communication group and directly communicate with each other without using an access point. Accordingly, data (e.g., image data, moving image data, and the like) can be directly transmitted from the first wireless communication device 100 to the second wireless communication device 200. Meanwhile, there is Wi-Fi Direct as a communication standard for direct communication between wireless communication devices based on IEEE 802.11.

In addition, the first wireless communication device 100 and the second wireless communication device 200 are wireless communication devices based on IEEE 802.15.1. There is Bluetooth (registered trademark) as a standard for direct communication between wireless communication devices based on IEEE 802.15.1.

In this embodiment, description is performed on the assumption that the first communication method is Bluetooth (registered trademark) and the second communication method is Wi-Fi. Wi-Fi is suitable to transmit/receive large-capacity data such as a large amount of image data, moving image data, and programs because it can allow high-speed large-capacity communication in contrast to Bluetooth (registered trademark). On the other hand, Bluetooth (registered trademark) is suitable for always-on connection due to low power consumption although a data capacity for transmitting/receiving thereby is small.

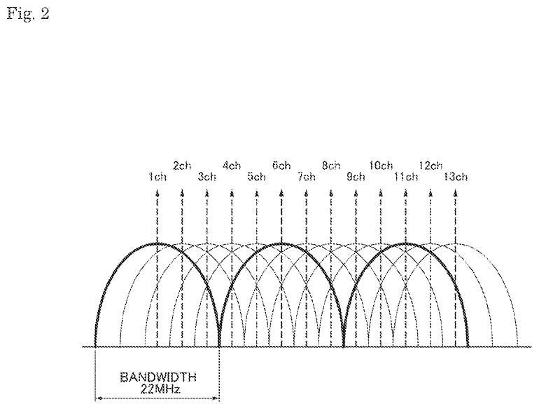

Here, channels of Wi-Fi will be described. Currently, Wi-Fi has two bands of 2.4 GHz and 5 GHz. In addition, each band is divided into a plurality of parts each having a specific channel width and the plurality of parts are respectively set as channels. In the 2.4 GHz band, 13 channels are set having a channel bandwidth of 22 MHz and adjacent channels and a part of the band overlap, as illustrated in FIG. 2. Accordingly, channels that do not interfere are 1ch, 6ch, and 11ch.

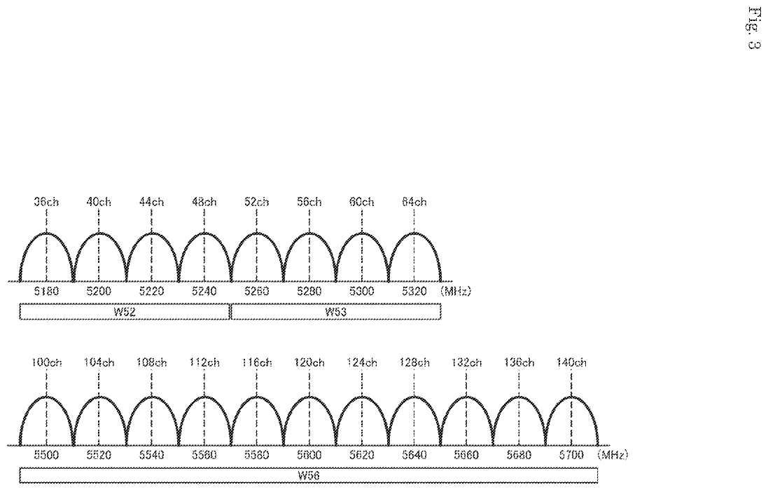

In addition, in the case of the 5 GHz band, there are 19 channels, as illustrated in FIG. 3, four channels 36, 40, 44, and 48 can be used in W52 of IEEE 802.11a, four channels 52, 56, 60, and 64 can be used in W53, and eleven channels 100, 104, 108, 112, 116, 120, 124, 128, 132, 136, and 140 can be used in W56. Since 20 MHz is allocated per channel, all the channels can be used without interference when a channel width is 20 MHz.

By using the 5 GHz band in addition to the 2.4 GHz band in this way, a time required for processing of executing Wi-Fi scanning and determining a channel to be used in order to use Wi-Fi increases.

In general, a communication device having a function of performing communication using Wi-Fi has a function of selecting and setting a channel during communication using Wi-Fi. The first wireless communication device 100 and the second wireless communication device 200 also have the function of selecting and setting a channel.

[1-2. Configuration of First Wireless Communication Device 100]

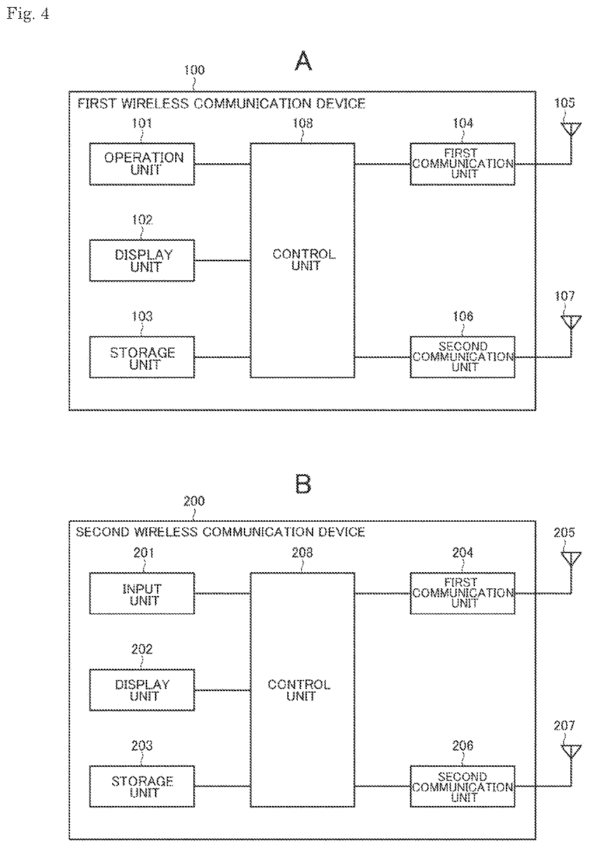

Next, a configuration of the first wireless communication device 100 will be described with reference to FIG. 4A. The first wireless communication device 100 includes an operation unit 101, a display unit 102, a storage unit 103, a first communication unit 104, a first antenna 105, a second communication unit 106, a second antenna 107, and a control unit 108.

The operation unit 101 is used for a user to input various instructions to the first wireless communication device 100. When the operation unit 101 is operated by the user, a control signal according to the operation is generated and supplied to the control unit 108. Then, the control unit 108 performs various types of processing corresponding to the control signal. The operation unit 101 may be a touch panel, a touch screen integrated with a display that is the display unit 102, or the like in addition to a physical button.

The display unit 102 is a display device or the like for displaying content data such as image and video, messages, a user interface of the first wireless communication device 100, and the like. The display device may be configured as, for example, a liquid crystal display (LCD), a plasma display panel (PDP), an organic electro luminescence (EL) panel, or the like.

The storage unit 103 is configured as a large-capacity storage medium such as a hard disk and a flash memory and stores various types of data such as content data, a program required for the first wireless communication device 100 to operate, information for communicating with other wireless communication devices and the like. For example, the storage unit 103 stores connection information (SSID, PSK, and the like) with respect to other wireless communication devices.

The first communication unit 104 performs Bluetooth (registered trademark) communication with the second wireless communication device 200 in cooperation with the first antenna 105 according to control of the control unit 108. For example, in transmission/reception of data in Bluetooth (registered trademark) communication, the first communication unit 104 transmits radio waves arriving at a short distance of about several meters from a Bluetooth (registered trademark) antenna and performs processing and the like necessary for Bluetooth (registered trademark) communication such as paring.

The second communication unit 106 performs Wi-Fi communication with the second wireless communication device 200 in cooperation with the second antenna 107 according to control of the control unit 108. For example, the second communication unit 106 performs reception processing such as down conversion, demodulation, decoding, and the like on a radio signal received by the antenna and supplies reception data obtained by the reception processing to the control unit 108. In addition, the second communication unit 106 performs transmission processing such as encoding, modulation, up conversion, and the like on transmission data supplied from the control unit 108 and outputs a high frequency signal obtained by the transmission processing to the antenna.

The control unit 108 includes a central processing unit (CPU), a random access memory (RAM), a read only memory (ROM), and the like. The CPU performs various types of processing according to programs stored in the ROM to issue commands, thereby performing control of the entire first wireless communication device 100 and each component thereof.

The control unit 108 performs Wi-Fi scanning for searching for Wi-Fi by scanning a predetermined frequency band through the second communication unit 106 and the second antenna 107.

The control unit 108 generates a handover request message for Wi-Fi connection with the second wireless communication device 200. This handover request message includes designated channel information for designating a specific channel to be used for communication with the second wireless communication device 200 among a plurality of Wi-Fi channels. Handover is automatic switching between communication base stations or communication methods, and represents switching from Bluetooth (registered trademark) communication to Wi-Fi communication in the present embodiment.

The first wireless communication device 100 determines a Wi-Fi channel to be designated in order to generate the designated channel information included in the handover request message. As a Wi-Fi channel to be designated, it is desirable to designate a channel with no interference or little interference other than channels that are already being used by neighboring Wi-Fi access points or other devices. A degree of interference can be confirmed by checking the radio field intensity of the channel. In addition, there is also a method by which the first wireless communication device 100 confirms Wi-Fi channels detected through Wi-Fi scanning and designates a channel other than the Wi-Fi channels.

Further, there is also a method of detecting noise of wireless communication through Wi-Fi scanning and determining an unused vacant channel on the basis of the noise.

The control unit 108 generates an association request frame that is a connection request frame for processing of Wi-Fi connection with the second wireless communication device 200. This association request frame is transmitted to the second wireless communication device 200 through communication according to the second communication unit 106 to make a Wi-Fi connection request. This association request frame includes designated channel information indicating a Wi-Fi channel to be used for connection.

The handover request message is transmitted to the second wireless communication device 200 through Bluetooth (registered trademark) communication according to the first communication unit 104. In addition, the association request frame is transmitted to the second wireless communication device 200 through Wi-Fi communication according to the second communication unit 106.

The first wireless communication device 100 has a function of selecting a Wi-Fi channel and performing communication when Wi-Fi communication is performed through the second communication unit 106 under the control of the control unit 108.

[1-3. Configuration of Second Wireless Communication Device 200]

Next, a configuration of the second wireless communication device 200 will be described with reference to FIG. 4B. The second wireless communication device 200 includes an operation unit 201, a display unit 202, a storage unit 203, a first communication unit 204, a first antenna 205, a second communication unit 206, a second antenna 207, and a control unit 208. The operation unit 201, the display unit 202, the storage unit 203, the first communication unit 204, the first antenna 205, and the second antenna 207 are the same as those in the first wireless communication device 100.

The first communication unit 204 performs Bluetooth (registered trademark) communication with the second wireless communication device 200 in cooperation with the first antenna 205 according to control of the control unit 208. For example, in transmission/reception of data in Bluetooth (registered trademark) communication, the first communication unit 204 transmits radio waves arriving at a short distance of about several meters from a Bluetooth (registered trademark) antenna and performs processing and the like necessary for Bluetooth (registered trademark) communication such as paring.

The second communication unit 206 performs Wi-Fi communication with the first wireless communication device 100 in cooperation with the second antenna 207 according to control of the control unit 208. For example, the second communication unit 206 performs reception processing such as down conversion, demodulation, decoding, and the like on a radio signal received by the second antenna 207 and supplies reception data obtained by the reception processing to the control unit 208. In addition, the second communication unit 206 performs transmission processing such as encoding, modulation, up conversion, and the like on transmission data supplied from the control unit 208 and outputs a high frequency signal obtained by the transmission processing to the antenna.

The second communication unit 206 is in a non-operating state (off state or sleep state) while the second wireless communication device 200 communicates with the first wireless communication device 100 through Bluetooth (registered trademark). When the handover request message in which a Wi-Fi channel has been designated is received from the first wireless communication device 100, the control unit 208 activates the second communication unit 206 such that the second wireless communication device 200 can perform Wi-Fi communication. This corresponds to activating a communication function of performing a second communication in the claims.

The control unit 208 generates an association response frame that is a connection response frame for an association request from the first wireless communication device 100. The association response frame is transmitted as a response to an association request from the first wireless communication device 100 through Wi-Fi communication according to the second communication unit 206, and Wi-Fi connection is established upon transmission of the association response frame to the first wireless communication device 100.

Further, the control unit 208 fixes to a Wi-Fi channel designated in channel designation information received from the first wireless communication device 100 and activates the Wi-Fi communication function (second communication unit 206). Accordingly, the first wireless communication device 100 and the second wireless communication device 200 can perform Wi-Fi communication only through the designated channel. Since the second communication unit 206 is activated in the designated channel by the first wireless communication device 100 in advance to perform communication, the second wireless communication device 200 need not perform Wi-Fi scanning. However, the second wireless communication device 200 may have a Wi-Fi scanning function.

The second wireless communication device 200 has the aforementioned function of selecting a Wi-Fi channel and performing communication when Wi-Fi communication is performed through the second communication unit 206 under the control of the control unit 208.

The first wireless communication device 100 and the second wireless communication device 200 are thus configured as described above.

[1-4. Communication Switching Processing]

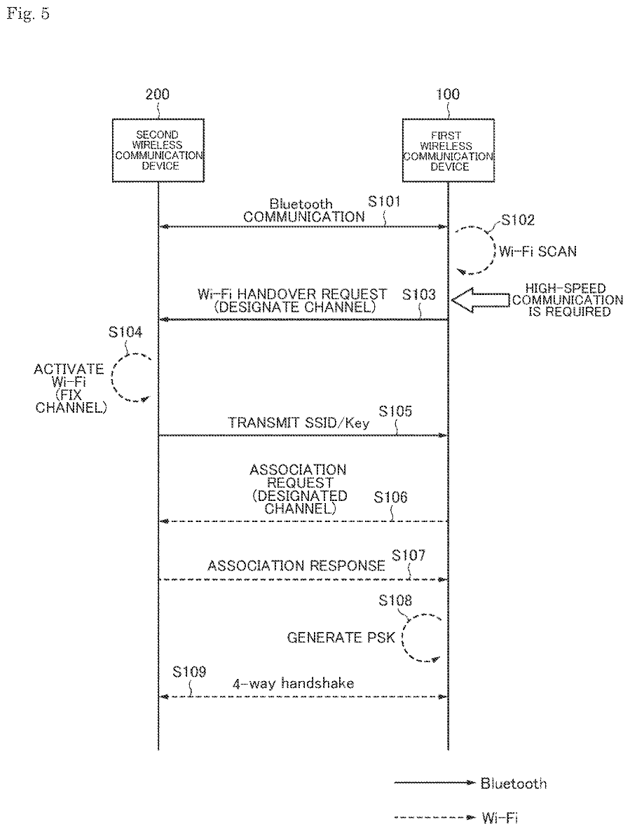

Next, communication switching processing between the first wireless communication device 100 and the second wireless communication device 200 will be described with reference to FIG. 5. In FIG. 5, straight lines between the first wireless communication device 100 and the second wireless communication device 200 represent operations with respect to Bluetooth (registered trademark) and broken lines represent operations with respect to Wi-Fi.

First, as represented by step S101, the first wireless communication device 100 and the second wireless communication device 200 are in an always-on connection state according to Bluetooth (registered trademark).

The first wireless communication device 100 executes scanning for Wi-Fi network searching as represented by step S102. Further, the first wireless communication device 100 performs Wi-Fi scanning all the time.

Then, when switching to Wi-Fi is instructed according to an input from a user applied to the first wireless communication device 100, the first wireless communication device 100 transmits a handover request message to the second wireless communication device 200 in step S103. This handover request message includes designated channel information for designating a specific channel to be used for connection among a plurality of Wi-Fi channels.

Further, even when the user does not instruct switching to Wi-Fi, the first wireless communication device 100 may perform processing upon determination that Wi-Fi is necessary on the basis of details of a user instruction for the first wireless communication device 100. For example, when the user instructs data transmission to the second wireless communication device 200, the first wireless communication device 100 may determine that Wi-Fi is necessary regardless of a data type and size. In addition, when the user instructs data transmission to the second wireless communication device 200, the first wireless communication device 100 may check a data type or size and determine that Wi-Fi is necessary when the data type is specific data (image data, moving image data, or the like) or the data size is equal to or greater than a predetermined size.

Next, the second wireless communication device 200 activates the Wi-Fi function (the second communication unit 206) thereof to perform Wi-Fi communication in a channel designated by the first wireless communication device 100 in step S104. Since the Wi-Fi function (the second communication unit 206) is activated in the channel designated by the first wireless communication device 100 in this manner, the second wireless communication device 200 need not activate the Wi-Fi function after executing Wi-Fi scanning and determining a channel. Accordingly, it is possible to reduce a time until Wi-Fi communication is available as compared to the conventional technology of activating the Wi-Fi function after executing Wi-Fi scanning and determining a channel.

Next, the second wireless communication device 200 transmits a service set identifier (SSID) and a Passkey that are connection information for Wi-Fi connection to the first wireless communication device 100 in step S105 after activation of the Wi-Fi function in step S104. The SSID is the ID of an access point in Wi-Fi (wireless LAN). The Passkey is a password (encryption key) for connecting to Wi-Fi.

Next, the first wireless communication device 100 performs an association request by transmitting an association request frame for Wi-Fi connection to the second wireless communication device 200 in the channel designated thereby in step S106. Here, the association request frame includes information on a channel requested to be used, which designates a channel to be used for communication.

Next, the second wireless communication device 200 performs an association response by transmitting an association response frame as a connection permission response to the association request from the first wireless communication device 100 in step S107.

Next, the first wireless communication device 100 generates a pre shared key (PSK) in step S108. The PSK is a technique used in wireless LAN connection and is a pre-common key used in two devices to be wirelessly connected.

Then, handshaking for establishment of communication is performed in the first wireless communication device 100 and the second wireless communication device 200 in step S109. Handshaking is to perform transmission and reception of communication speeds, data formats, other arrangements, and parameters before full-scaled communication is performed after establishment of a communication path in order to perform communication between different devices.

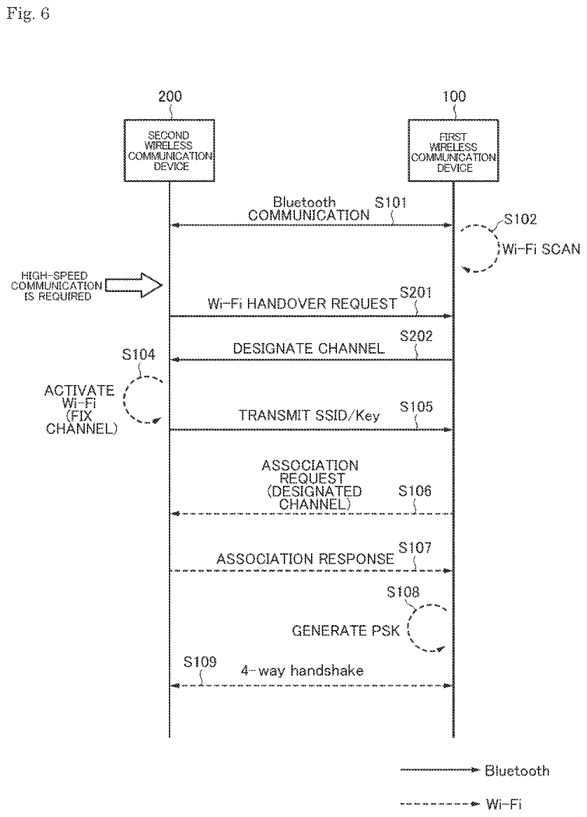

Meanwhile, the handover request message for Wi-Fi connection may be transmitted from the second wireless communication device 200 instead of the device that designates a channel, as illustrated in step S201 of FIG. 6. In this case, this handover request message does not include designated channel information. Accordingly, the first wireless communication device 100 that has received the handover request message from the second wireless communication device 200 transmits designated channel information indicating a channel to be used for Wi-Fi communication to the second wireless communication device 200 through Bluetooth (registered trademark) communication, as illustrated in step S202. Processing other than the aforementioned steps is the same as the processing described with reference to FIG. 5.

As described above, switching from Bluetooth (registered trademark) connection to Wi-Fi connection according to the first wireless communication device 100 and the second wireless communication device 200 is performed. According to this method, since Wi-Fi connection is performed in a channel designated in advance, stable and high-speed communication can be established by designating a stable channel. In addition, the second wireless communication device 200 need not perform Wi-Fi scanning and determine a channel in order to connect to the first wireless communication device 100, and thus switching connection from Bluetooth (registered trademark) to Wi-Fi can be performed within a shorter time than in conventional technologies.

As a specific usage example of the present technology, there is an example in which the first wireless communication device 100 is a smartphone and the second wireless communication device 200 is a camera, for example. When multiple pictures captured by the camera are transmitted from the camera to the smartphone, Bluetooth (registered trademark) cannot transmit the pictures or requires a long time to transmit the pictures because a communication speed is low. In such a case, it is possible to transmit multiple pictures to the smartphone through high-speed communication of Wi-Fi within a shorter time than in conventional technologies by switching Bluetooth (registered trademark) connection to Wi-Fi using the present technology.

Further, in a case where the first wireless communication device 100 is a camera and the second wireless communication device 200 is a smartphone, multiple pictures can be transmitted from the camera to the smartphone through Wi-Fi communication within a short time according to switching from Bluetooth (registered trademark) connection to Wi-Fi in the same manner.

The first wireless communication device 100 and the second wireless communication device 200 may be configured as devices that perform switching processing of the present technology, or the first wireless communication device 100 and the second wireless communication device 200 may be configured by operating a program in an existing wireless communication device. The program may be installed in the wireless communication device in advance, or downloaded or distributed through storage media or the like and installed by a user. Further, the functions of the present technology may be realized not only by a program but also as a combination of a dedicated device, a circuit, and the like using hardware having these functions.

### 2. MODIFIED EXAMPLES

Although the embodiment of the present technology has been specifically described above, the present technology is not limited to the above-described embodiment, and various modifications based on the technical spirit of the present technology are possible.

The first wireless communication device 100 and the second wireless communication device 200 are not limited to a smartphone and a camera and may be any device having the first and second communication functions, such as a smart speaker, a communication robot, a stationary personal computer, a laptop computer, a tablet terminal, a portable game machine, and a wearable device.

Communication according to the first communication unit 104 of the first wireless communication device 100 and the first communication unit 204 of the second wireless communication device 200 is not limited to Bluetooth (registered trademark) and may be other methods. As other methods, Bluetooth Low Energy that is a low power consumption communication standard of Bluetooth (registered trademark), NFC, and the like may be conceived.

Although an example of connection of two devices of the first wireless communication device 100 and the second wireless communication device 200 has been described in the embodiment, the present technology can also be applied to connection of three or more devices.

Although the second wireless communication device 200 transmits the connection information (SSID and Passkey) to the first wireless communication device 100 in description of FIG. 5 and FIG. 6, the second wireless communication device 200 need not transmit the connection information if the connection information is stored in the first wireless communication device 100 in advance. In this case, the first wireless communication device 100 may be notified of activation of the second communication unit 206 (Wi-Fi communication function) by the second wireless communication device 200 through first communication. The first wireless communication device 100 that has received this notification can transmit the association request frame to the second wireless communication device 200 to establish Wi-Fi connection. However, even when the first wireless communication device 100 is not notified of activation of the second communication unit 206 (Wi-Fi communication function) by the second wireless communication device 200, the first wireless communication device 100 may transmit the association request frame on the assumption that the second wireless communication device 200 has activated the Wi-Fi communication function after the elapse of a predetermined period from transmission of the handover request message.

The present technology can also be configured as follows.

(1)

A communication method including:

transmitting, by a first wireless communication device, channel designation information designating a channel to be used for a second communication to a second wireless communication device through a first communication; activating, by the second wireless communication device, a communication function such that the second communication is performed through the designated channel; and

transmitting, by the first wireless communication device, a connection request for the second communication using the designated channel to the second wireless communication device.

(2)

The communication method according to (1), wherein the second communication has a communication speed higher than that of the first communication.

(3)

The communication method according to (1) or (2), wherein the first communication has lower power consumption than that of the second communication.

(4)

The communication method according to any one of (1) to (3), wherein the first communication is Bluetooth.

(5)

The communication method according to any one of (1) to (4), wherein the second communication is Wi-Fi.

(6)

The communication method according to any one of (1) to (5), wherein the second wireless communication device transmits connection information used for the second communication to the first wireless communication device through the first communication.

(7)

The communication method according to any one of (1) to (6), wherein the first wireless communication device and the second wireless communication device are always connected to each other through the first communication.

(8)

A communication system including:

a first wireless communication device; and

a second wireless communication device, wherein

the first wireless communication device transmits channel designation information designating a channel to be used for a second communication to the second wireless communication device through a first communication,

the second wireless communication device activates a communication function such that the second communication is performed through the designated channel, and

the first wireless communication device transmits a connection request for the second communication using the designated channel to the second wireless communication device.

(9)

A wireless communication device configured to transmit channel designation information designating a channel to be used for a second communication to another device through a first communication and

to transmit a connection request for the second communication using the designated channel to the other device.

(10)

A wireless communication device configured to receive channel designation information used for a second communication transmitted from another device through a first communication and

to activate a communication function such that the second communication is performed through the designated channel.

### REFERENCE SIGNS LIST

10 Communication system

100 First wireless communication device

200 Second wireless communication device

1. A communication method comprising:
transmitting, by a first wireless communication device, channel designation information designating a channel to be used for a second communication to a second wireless communication device through a first communication;
activating, by the second wireless communication device, a communication function such that the second communication is performed through the designated channel; and
transmitting, by the first wireless communication device, a connection request for the second communication using the designated channel to the second wireless communication device.

2. The communication method according to claim 1, wherein the second communication has a higher communication speed than that of the first communication.

3. The communication method according to claim 1, wherein the first communication has lower power consumption than that of the second communication.

4. The communication method according to claim 1, wherein the first communication is Bluetooth.

5. The communication method according to claim 1, wherein the second communication is Wi-Fi.

6. The communication method according to claim 1, wherein the second wireless communication device transmits connection information used for the second communication to the first wireless communication device through the first communication.

7. The communication method according to claim 1, wherein the first wireless communication device and the second wireless communication device are always connected to each other through the first communication.

8. A communication system comprising:
a first wireless communication device; and
a second wireless communication device, wherein
the first wireless communication device transmits channel designation information designating a channel to be used for a second communication to the second wireless communication device through a first communication, the second wireless communication device activates a communication function such that the second communication is performed through the designated channel, and
the first wireless communication device transmits a connection request for the second communication using the designated channel to the second wireless communication device.

9. A wireless communication device configured to transmit channel designation information designating a channel to be used for a second communication to another device through a first communication and
to transmit a connection request for the second communication using the designated channel to the other device.

10. A wireless communication device configured to receive channel designation information used for a second communication transmitted from another device through a first communication and
to activate a communication function such that the second communication is performed through the designated channel.
